(19) United States
(12) Patent Application Publication
(10) Pub. No.: US 2009/0048936 A1
(43) Pub. Date: Feb. 19, 2009

(54) Method and system for RFID transaction integrity utilizing an EEPROM

(76) Inventors: John W. Lerch, Chapel Hill, NC (US); Joshua M. Girvin, Arlington, VA (US); M. Christopher Wenneman, Seattle, WA (US); Peijen Shawn Mou, New York, NY (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/082,977

(22) Filed: Apr. 14, 2008

Related U.S. Application Data
(60) Provisional application No. 60/911,531, filed on Apr. 13, 2007.

(51) Int. Cl. G06Q 20/00; G08B 13/14; G06Q 30/00

(52) U.S. Cl. 705/17; 340/572.1; 705/41

(57) ABSTRACT

A method for purchasing goods in a cashless operation utilizing an RFID apparatus is provided. The RFID apparatus includes an EEPROM, the EEPROM being formatted to include a first group of data blocks and a second group of data blocks. Transaction data is stored in the first group of data blocks. When placing an order for goods or services, an RFID scanner scans the EEPROM. The RFID scanner reads a start block pointer value from a data block of the EEPROM. The pointer value corresponds to the address of the last written of the first group of data blocks or second group of data blocks. Data is then read from the last written group of data blocks. As the transaction is processed, the transaction data is modified in accordance with a purchase order to create modified data. The modified data is written to the second group of data blocks. Once it is determined that the writing to the second group of data blocks is successful, the pointer value stored in the EEPROM is changed to indicate the second group of data blocks.

### RELATED APPLICATION

This application claims the benefit of U.S. Provisional Application No. 60/911,531, filed on Apr. 13, 2007. The entire teachings of the above application are incorporated herein by reference.

### BACKGROUND OF THE INVENTION

Radio-frequency identification (RFID) technologies have been incorporated into wristbands and are being used for such things as identification, access control and age verification. For example, various venues have begun to use RFID wristbands to quickly and uniquely identify patrons that have access to restricted areas, such as back stage events, alcoholic beverage sales, etc. These wristbands can be made using a narrow band of plastic or other suitable material and a prefabricated RFID tag, so that they are inexpensive to produce and easy to use.

RFID wristbands have also been employed at various venues to purchase goods and services as part of a cashless purchasing system. Typically, these venues include multiple locations which are part of the cashless purchasing system. When a customer purchases goods or service from one of these locations, the customer's account is charged at the time of the sale and the purchase information is stored in a database of the purchasing system.

These purchasing systems only work when all purchase locations are in communication (“online”) with the purchasing system. As commercial venues become more sophisticated, more diverse in their offerings for cashless purchases, and larger in physical size, the adoption of mobile RFID scanners for use as point-of-sale (POS) devices will increase. Mobile devices in wireless communication with a base station, are susceptible to dead zones, dead time when even in a “hot” zone, the base station or central hub is unable to communicate, such as in instances where bandwidth is unavailable so that competing portable POS devices clog the bandwidth making communication temporarily impossible. As such, offline purchases using the RFID wristband would not be available. Therefore, in instances where cashless purchasing is the only available means to buy goods or services, offline purchase locations would ultimately lead to fewer sales of goods or services.

To facilitate a more efficient purchase methodology utilizing the RFID cashless purchase system, information utilized during the transaction may be stored on the RFID wristband. An EEPROM may be utilized. However, utilization of the EEPROM while solving one problem, namely speeding up the transaction by not requiring an entire data exchange with a central server, brings its own problems such as the integrity of the data written to, and read from, the EEPROM. Therefore, the prior art EEPROM RFID wristbands lend themselves to erroneous transactions based upon corrupted data and an inability to verify the authorization of the transaction.

This issue is particularly prevalent when data is updated by performing an operation of overwriting the old data stored at the wristband. In accordance with the prior art, partial writes could occur to the EEPROM corrupting the transaction. By way of example, if the RFID tag is briefly in an active field of an RFID reader, a multiple block write operation will begin, but may not finish. If the write operation included changing spending limits or deducting a transaction amount from an overall amount, and if the write operation did not completely occur, then it would not be clear whether the current values at the EEPROM were the previous values or the correct updated values.

Accordingly, a method and system for using RFID technology to allow for cashless purchasing of goods or services in both online and offline situations is desired.

### SUMMARY OF THE INVENTION

A method for purchasing goods in a cashless operation utilizing an RFID apparatus is provided. The RFID apparatus includes an EEPROM, the EEPROM being formatted to include a first group of data blocks and a second group of data blocks. Transaction data is stored in the first group of data blocks. When placing an order for goods or services, an RFID scanner scans the EEPROM. The RFID scanner reads a start block pointer value from a data block of the EEPROM. The pointer value corresponds to the address of the last written of the first group of data blocks or second group of data blocks. Data is then read from the last written group of data blocks. As the transaction is processed, the transaction data is modified in accordance with a purchase order to create modified data. The modified data is written to the second group of data blocks; i.e., the group of data block which is not the last written data blocks. Once it is determined that the writing to the second group of data blocks is successful, the pointer value stored in the EEPROM is changed to indicate the second group (last written) of data blocks.

A system for transacting purchases for goods and services is provided using a point-of-sale computer running standardized point-of-sale application software and application programming interface software for RFID scanning and tracking. The system includes an RFID reader and a server, which hosts RFID tag information. The standardized point-of-sale application software queries the RFID application programming interface for payment and the RFID queries the RFID reader for RFID tag information and then queries the server for account information associated with the RFID tag. If the account associated with the RFID tag has sufficient funds for payment, the RFID application programming interface software provides payment to the standardized point-of-sale software to complete the sale. Optionally, the RFID tag may be coupled to an EEPROM and may pass information from the EEPROM to the RFID reader.

A method for preventing child abduction at limited-access venues is also provided. When an adult enters a venue with children, each of the adult and children are issued an RFID tag, typically in the form of a tamper-proof bracelet. The adult's RFID tag is then associated with the RFID tags on each child for whom the adult is responsible. When children attempt to depart the venue at a later time, their tags are scanned along with the adult attempting to depart with the children. If the childrens' RFID tags match the RFID tags with which the adult's RFID tag is associated, then the children are allowed to depart the venue with the adult. However, if the childrens' RFID tags do not match the RFID tags with which the adult's RFID tag is associated, then the children will not be permitted to depart the venue with the adult. Optionally, the information on child RFID tags associated with an adult's RFID tag may be stored on an EEPROM coupled to the adult's RFID tag.

A method for allocating money from a common spending account to individual accounts is provided. When a party of people enter a venue, each is issued an RFID tag, typically in the form of a tamper-proof bracelet. Each person's RFID tag is associated with the common spending account and is also assigned its own individual spending account. Each RFID tag is also associated with an allocation percentage. When money is placed in the common account, an amount in accord with the allocation percentage associated with each RFID tag is allocated to the individual account associated with each RFID tag. Optionally, the allocation percentage and individual account balance may be stored on an EEPROM coupled to each RFID tag.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a system diagram of an embodiment a cashless purchasing system according of the present invention;

FIG. 2 is a flow chart depicting steps of performing a cashless purchase utilizing the cashless purchasing system of FIG. 1 in accordance with the invention;

FIG. 3 is a block diagram of a memory circuit of the present invention;

FIG. 4 is a table representation of the memory of an EEPROM in accordance with the present invention;

FIG. 5 is a flow chart depicting the steps of reading and writing to the EEPROM in accordance with the present invention;

FIG. 6 is a schematic diagram of a point-of-sale device operating standardized point-of-sale software and RFID application programming interface software;

FIG. 7A is a schematic representation of a common account and sub-accounts with an initial allocation of money to sub-accounts;

FIG. 7B is a schematic representation of the common account and sub-accounts of FIG. 7A after a second allocation of money to the common account and sub-accounts;

FIG. 8A is a representation of a print-out, showing a child's RFID tag matching an RFID tag listed on an adult's RFID tag; and

FIG. 8B is a representation of a print-out, showing a child's RFID tag not matching any RFID tag listed on an adult's RFID tag.

### DETAILED DESCRIPTION OF THE INVENTION

A description of example embodiments of the invention follows.

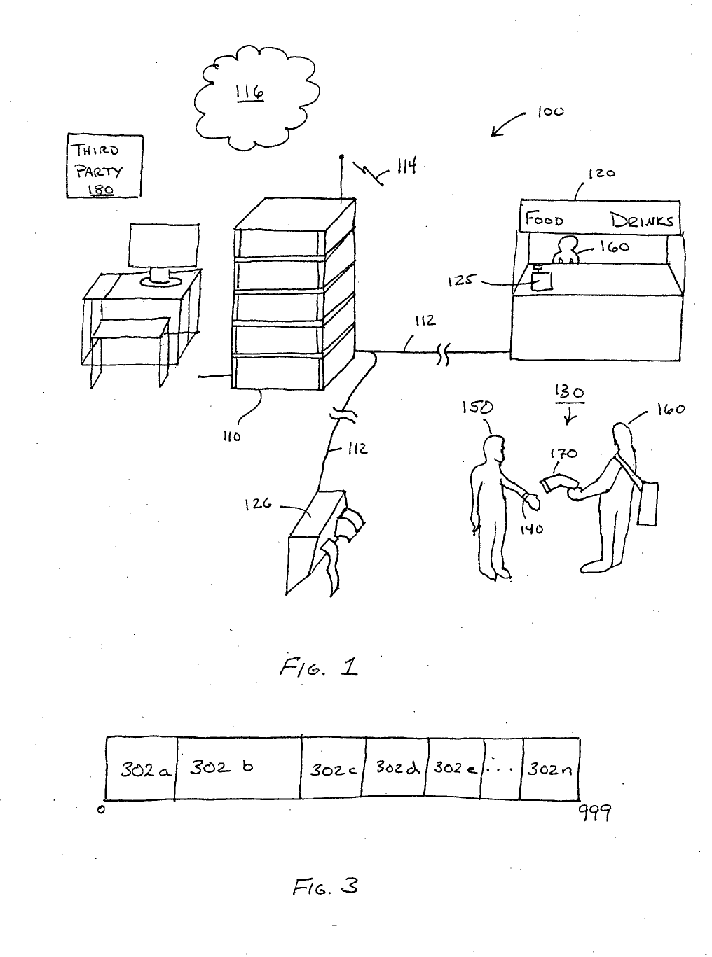

FIG. 1 is a diagram of a system 100 of a cashless purchasing system 100 according to principals of the present invention. The cashless purchasing system 100 can be useful for purchasing goods or services at venues, such as sporting events, music concerts, conventions, conferences and other gatherings where customers may use RFID devices to make cashless purchases. Goods or services include at least one product or service, which are offered for sale at various locations throughout a venue.

In general, the cashless purchasing system 100 of the present invention allows a customer 150 wearing RFID wristbands 140 to make cashless purchases at remote locations (120, 130), whether or not point-of-sale devices 125, 170 at the locations (120, 130) are in communication with a centralized hub 110 of the cashless purchasing system 100. A typical system 100 includes the centralized hub 110 and various point-of-sale locations 120, 130. The centralized hub 110 can include computer means for processing and storing the transactions, such as a central processing unit, a database storage unit, input/output devices, and other known devices. The point-of-sale locations utilize fixed/stationary point-of-sale device 125 or remote/mobile point-of-sale device 170. Point-of-sale locations 120, 130 are typically operated by vendors 160 employed by the venue but may work independently as well.

The centralized hub 110 maintains information related to purchasing within its associated database. This information can include customer account information and purchase order information. The customer account information includes information associated with the customer 150 wearing the RFID wristband 140, such as the RFID serial number, credit card information, spending limits, and access authorization to name a few. The purchase order information may include information associated with the goods or services purchased, for example pricing of the goods or services, transaction time, and any transaction indicating code.

The centralized hub 110 communicates with, i.e., is on line with, one or more point-of-sale devices 125, 170 at locations 120, 130 through wired links 112 or wireless links 114. The centralized hub 110 also communicates to third party databases 180 such as credit card companies or banks over the Internet 116 or other means to complete the purchase transaction. In some embodiments, the database of centralized hub 110 can be in communication with a printer 126 remote from or at (not shown) the point-of-sale locations 120, 130. The printer 126 allows the customer 150 to print a receipt related to his/her purchases. Although the centralized hub 110 is shown as one unit, it can be in multiple units located throughout the venue or external to the venue.

As discussed generally above, each location 120, 130 includes a point-of-sale device, such as an RFID reader/interrogator for reading/writing information relating to the purchase from/to the RFID wristband 140. The RFID reader/interrogator can be external to the point-of-sale device such as point-of-sale terminal 125 or within the point-of-sale device such as with mobile point-of-sale device 170.

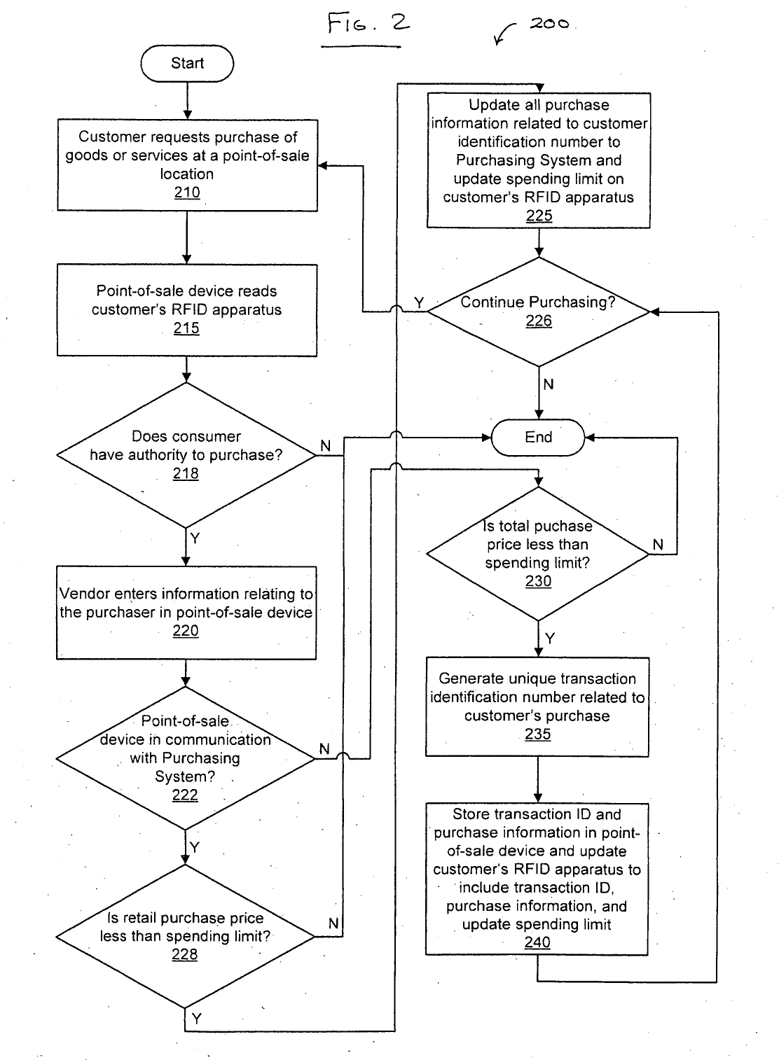

The RFID wristband 140 typically includes a passive RFID microchip and an antenna as known in the art, however, active RFID circuits can be used. The RFID microchip stores a unique serial number that is associated with the customer's 150 account, which is stored in the centralized database 110. The RFID microchip also includes a memory device, such as an EEPROM 300, that is used to store and update RFID wristband 140 with information related to the purchase or the customer's account. As explained with reference to FIG. 2, the ability of point-of-sale devices 125, 170 to write to the EEPROM 300 on the wristband 140 allows the system 100 to operate even if communication does not exist between the centralized hub 110 and the purchase locations 120, 130 (“off line”).

FIG. 2 shows a flow chart illustrating one process 200 in which a customer 150 can purchase goods or services using system 100 of FIG. 1. The customer 150 requests to purchase goods or service from a vendor 160 in a step 210 at a point-of-sale location 120, 130. Such locations may be in areas such as customer seating locations within the venue's concourse, at concession stands within the venue, or even locations outside of the venue. The vendor 160 operates the point-of-sale device (RFID reader/interrogator) 125, 170 to read the customer's 150 RFID wristband 140 in a step 215, in order to identify the customer's 150 account.

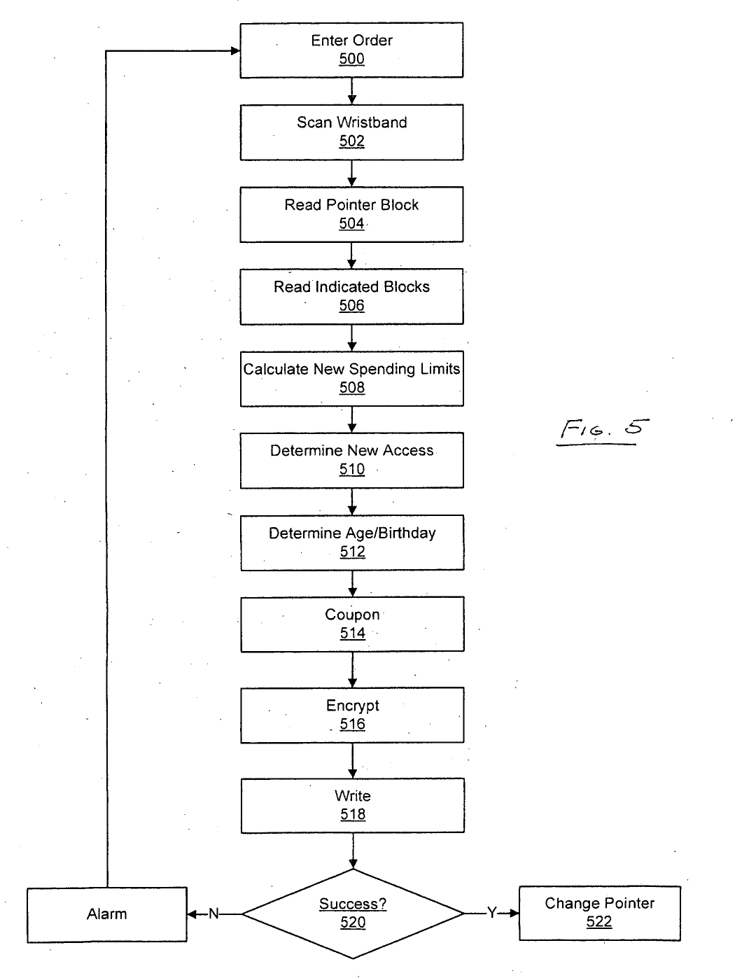

It follows that the point-of-sale devices 125, 170, and in particular device 170, include a microprocessor, memory and antenna associated with the RFID scanner as is known in the art. In this way, point-of-sale devices 125, 170 can process information and retain information for real-time or later processing in connection with either RFID wristband 140 or central hub 110 even during or following an offline time period. As seen in FIG. 5, point-of-sale device 170 by way of example includes an RFID scanner 172, for scanning RFID wristband 140, memory 174 for storing data scanned or created by point-of-sale device 170 and an antenna 176 for transmitting data to central hub 110. An alarm 182 is provided to indicate alarm conditions. All is done under the control of a microprocessor 178.

In an optional embodiment, involving alcoholic beverage sales by way of non-limiting example, the system 100 determines at the outset of the transaction if the customer 150 has the authority to make the requested purchase in step 218. This may be done either by storing a flag in RFID wristband 140 or hub 116 to indicate authorization to participate in an activity or access an area, or, in the case of alcohol, to store the user's age or birthdate in EEPROM 300.

If the hub 116 or point-of-sale device 170 determines that customer 150 does not have authority for such purchase, the vendor can inform the customer to talk to authorized personnel regarding gaining authorization. It should be understood that such determinations may also be made by smart point-of-sale devices 125, 170 with RFID wristband 140 storing the flag information.

The vendor 160 enters the purchase request into the system 100 in a step 220. Next, in step 222, the system 100 determines if the point-of-sale device 125, 170 is in communication with the centralized hub 110 (“on-line”).

If the point-of-sale device 125, 170 is in communication with the centralized hub 110, the system 100 determines if the purchase price of the selected goods or services is less than or equal to the customer's spending limit associated with the customer's account by checking the customer's account stored in the centralized hub 110 in a step 224. If the purchase price is within the specified limits, the system 100 updates the information stored in the centralized hub 110 with the purchase information related to the customer's identification number and processes the order in step 225, At the same time, the system 100 updates a spending limit stored on the RFID wristband 140 in step 225. If the customer 150 decides to continuing purchasing in step 226, the steps are repeated starting at step 210.

If the point-of-sale device 125, 170 is not in communication with the centralized hub 110, the point-of-sale device 125, 170 determines if the purchase price of the selected goods or services is less than or equal to the customer's spending limit associated with the customer's account by checking a spending limit field stored on the EEPROM 300 of the RFID wristband 140 in a step 230. If the purchase price is within the specified limits, the point-of-sale device 125, 170 generates a unique transaction identification number associated with the customer's purchase in step 235. The point- [symbol] of-sale device 125, 170 then stores the purchase information related to the transaction identification number within a database contained in the point-of-sale device 125, 170 for later transmission to the central database of centralized hub 110 in a step 240. The point-of-sale device 125, 170 also stores purchase information, such as the related transaction identification number, purchase amount, and purchase date and time to specified fields in the EEPROM 300 of the RFID wristband 140 and also updates the spending limit field in step 240.

The transaction identification number and/or time-date “stamp” ensures the customer 150 will not be charged twice for the same transaction. If the customer 150 decides to continue purchasing, the steps are repeated starting at step 210. In some embodiments, transaction identification number and related purchase information can be stored in the EEPROM 300 whether or not the point-of-sale device 125, 170 is in communication with the centralized hub 110. It should be noted that the above example was used as a backup method to allow the system to operate when off line. However, it is also possible to use the EEPROM 300 as a portable database to reduce the amount of data which must be exchanged during a transaction; expediting the transaction.

In some instance a customer 150 may wish to print a receipt of the transactions stored on the wristband 140. As such, the customer can go to a remote printer 126 that also includes an RFID reader/interrogator. The printer 126 will read the information stored on the wristband and print a receipt of the customer's last transaction. The printer 126 can also provide other information to the customer, such as the amount remaining on the customer's spending limit, or a detailed list of all transactions. In instances were the printer 126 is in communication with the centralized hub 110, the system 100 can be updated with information stored on the RFID wristband 140. Further, because the RFID wristband 140 has limited space for storing purchase information, the receipt printer 126 may also be implemented to write to the wristband, allowing for managing the data in the memory circuit. As such, data could be modified or deleted from EEPROM 300 for such purposes as accommodating information for future purchases, and or correcting errors in original data storage.

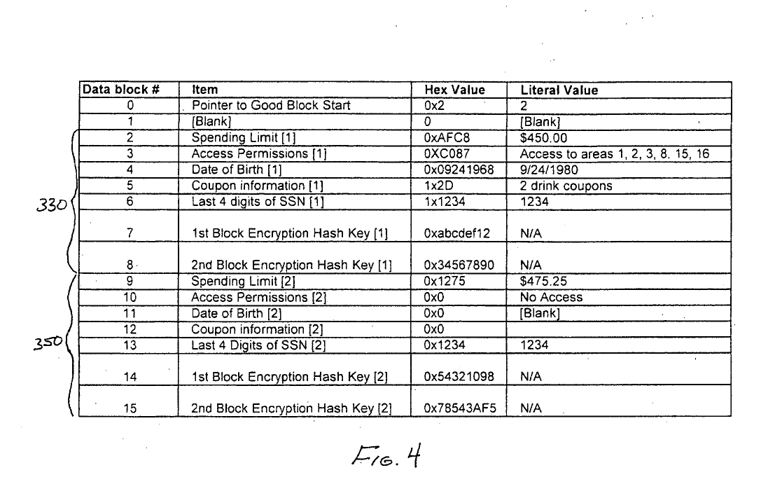

FIG. 3 shows a block diagram of the memory circuit of the RFID wristband 140 of the preceding figures. Typical passive RFID microchips include a 1 k memory circuit, such as EEPROM 300, although any size memory circuit can be used The memory of EEPROM 300 can be partitioned into defined memory locations 302a . . . 302n, wherein each memory location 302a . . . 302n is defined for a particular purpose. For example, segment 302a may be defined for a spending limit. Segment 302b may be defined for the authorization flag. Segments 302e . . . 302n may be defined as personal information such as account ID, name, credit card information, transaction codes or purchasing preferences, which may be used by point-of-sale device 125, 170 or hub 110 to effect purchases. As such, the RFID reader/interrogator containing a memory map to such locations can read/write to the memory location for the desired purpose/function. The size of the memory locations 302a . . . 302n can be allocated depending on the desired purpose/function.

Reference is now made to FIG. 4 in which a table showing a specific arrangement of data blocks corresponding to the segments of EEPROM 300 is provided. By way of non-limiting example, there are sixteen data blocks, each having a hexadecimal value and a literal value. Each data block is assigned a specific functionality. It should be understood that the data blocks are arranged in no particular order, this order is by way of example only so long as the reader contains a memory map corresponding to the EEPROM format and reads and writes to the data block locations for the desired purpose and function. Additionally, each data block may have different functionality to support specific applications. In a preferred non-limiting embodiment, each data block size is 32 bits and the information is stored in ASCII.

As can be seen, data block 0 functions as a pointer to the start block, i.e., the block at which the reader should begin its read or write function. In this example, block 1 is left intentionally blank. Blocks 2-8 form a first group of data blocks 330, and blocks 9-15 form at least a second group of data blocks 350. In this example, blocks 9-15 make up the earlier written data section 350 of the memory blocks of the EEPROM 300. In this example, for ease of explanation, blocks 9-15 correspond to the initial EEPROM state upon issuance. Blocks 2-8 provide parallel structure to blocks 9- [symbol] 15 and correspond to a spending limit block, access permissions block, date of birth, coupon information, social security number, and encryption blocks.

The blocks of section 330 are the next to be written blocks as will be discussed below. Block 9 includes a spending limit, in this non-limiting example, $475.25. Spending limit, in this example, is stored as value in cents in hex, so $100.00 is equal to 10000, which is equal to 0x2710 in hex. Block 10 provides access permission. In other words, it identifies which physical areas of the park customer may access. Access may be a function of age, height, weight, or type of purchased package. Using 32 bit data blocks, areas 1 to 128 may be designated and are indicated by a 1 in the corresponding bit position. For example, 0x8 is equal to b1000 and indicates access to area 4. Here, no access privileges are initially assigned, as indicated by block 10.

Blocks 11-13 contain user-specific information in this non-limiting example, such as the date of birth of the wearer, which as discussed above is utilized by the reader/interrogator 170 to control access to goods and areas of the event, coupon information which the user may be entitled to as part of special promotions, and the last 4 digits of the social security number utilized here as an exemplary wearer ID. In this example, birthday is stored in ASCII as: YYYMMDD. To ensure the integrity of the transaction and to prevent hacking, the data may be encrypted; the encryption/hash keys being stored in blocks 14 and 15.

During operation, the reader/interrogator 170 looks for a pointer for the start block value in data block 0. Depending upon the address of the start block, reading will occur in that area. The address for the start will be for the data block group 330, 350, which corresponds to the last written data. In other words, if the data being changed is found in group 350, then data is read from group 350 and writing will occur in group 330 to preserve the data values stored in group 350 in case writing is incomplete. Once writing has been successfully completed, then the data to be preserved will be the most recent data change found in section 330 and the pointer will point to data block 2 as its starting point. In this way, writing alternates between the new write group and the last written group on every other write so that the writing occurs in an area which does not overwrite the data to be modified until the new write is correct and stored. In this way, the integrity of the base data is maintained throughout the write process.

More specifically, in our example, data is originally stored (the last written data) in group 350. Therefore, when the RFID wristband 140 was created, the user ID was stored in data block 13 and a prespending limit was stored in data block 9. Encryption blocks 14 and 15 were also enabled. However, the remaining information with respect to customer 150 is left blank to be determined upon arrival at the venue. Assuming for the purposes of the example, customer 150 wishes to buy a “combination” package allowing access to certain areas of the venue, identifies himself as older than 18 years, and the combination package being purchased includes two drink coupons.

When customer 150 presents himself at the venue, a vendor 160, utilizing an interrogator such as interrogator 170 scans the RFID wristband 140 and upon proof of ID determines the birth date of the wearer. Vendor 160 processes the purchase of the combination package costing $25.25 in our example.

Reference is now made to FIG. 5 in which a flow chart for processing the transaction utilizing EEPROM 300 is provided. In a step 500, vendor 160 enters the order for the combination package into the system. He then scans the RFID wristband 140 with reader/interrogator 170 in a step 502. Reader/interrogator 170 reads pointer data block 0 in a step 504 because the protocol in this exemplary, but non-limiting, embodiment is that the pointer is found at data block 0. Because original (last written) data in our example is group 350 of the EEPROM 300, the pointer is originally set to 9 so that reader/interrogator 170 reads blocks 9-13 in a step 506. The data is decrypted using data blocks 14 and 15.

System 100 subtracts the price of the package ($25.25) from the available spending limit as stored in block 9 and determines the new spending limit of $450.00 in step 508. Because the combination package enables access to certain areas in the venue, reader/interrogator 170 determines the appropriate access permissions; in our example areas 1, 2, 3, 8, 15, 16.

This may be a fresh write, or it may be a comparison function with the access permission defined in data block 10 so that what is written in data block is really the sum of the new permissions granted by system 100 in accordance with the ticket purchased and the original access.

As discussed above, to enable access to certain restricted areas above and beyond access permissions, the date of birth may be stored as determined by a driver's license or other authenticating document in a step 512. In a step 514, any new coupon information is determined. By way of example, either replacement coupon information may be determined under an OR logic function of the existing coupon information from data block 12 is read combined with any new coupon information to be stored in data block 5 as new coupon information. In our example, the combination comes with two drinks, so that two drink coupons are awarded. In accordance with the invention, once a drink coupon is consumed, the information will be rewritten back in data block 12 as one drink coupon. In a step 516, new encryption hash marks are calculated. In a step 518, the data is then written to blocks 2-8. So, in summary, new spending limit $450 is written to block 2, the new access permissions are written to block 3, the date of birth is written to block 4, coupons are written to block 5, the preexisting ID is transferred from block 13 to 6, because no editing status change is required. It should be noted that the new data to be written may be recalculated by creating new data from scrath, or by use of a summing function at reader/interrogator 170

In a step 520, it is determined whether or not a successful write has occurred. If it has, then the pointer is changed in a step 522 to point to block 2. Block 9 has now become the obsolete data and therefore can be rewritten, while blocks 2-8 of group 330 have become the new or last written data which will form the basis of the next data to be modified.

If a write is unsuccessful, then an alarm sounds in step 524. The process is returned to step 502 and the scanning begins again and writing is attempted to blocks 2-8. In this way, the attempt to write has not corrupted any of the baseline data contained in data blocks 9-15. The pointer remains unchanged until a successful write preventing a change in the pointer, preventing inadvertent overwriting of the baseline data. If there is never a successful write, at least the baseline data will contain uncorrupted, albeit old, data. The system may still function as current data as discussed above is stored in centralized hub 110 for later downloading.

In accordance with the novel methodology discussed above, the integrity of the data is maintained. However, the integrity of the transactions should also be ensured. In paper-based transactions, this is often done by the use of a signature or the presentation of the card verification value (CVV2) data on the credit card. However, requiring purchasers to stand in line and wait for paper to be signed or to present a credit card for each and every transaction unnecessarily slows the process; discouraging purchases.

Accordingly, in another embodiment of the invention, a digital signature is stored as a data block such as memory location 302e. The digital signature may be encoded as a vector, map or similar data configuration. In this way, the digital signature is not stored centrally, such as in such a place as central hub 110 and therefore, cannot be hacked or easily stolen.

In step 502, when the wristband is scanned, or at step 522 confirmed successful transaction and write, the signature would be read from memory location 302e of EEPROM 300, displayed for acceptance by customer 150 and attached to the transaction as it is processed, but not stored, by central hub 110.

Because RFID wristband 140 is a temporary storage medium, this would allow the repeated use of the signature without permanent storage in a central database. It allows customer 150 to maintain control of the use of their signature and reduces the exposure to hacking and the resultant counterfeiting.

In a similar transaction, rather than storing a spending limit in data block 9, in the example above, credit card information utilized for processing transactions by central hub 110 may be stored or a credit card number may be stored in the database associated with central hub 110. In a separate location 302 of EEPROM 300, the CVV2 data may be stored. The transaction is not completed by central hub 110 until it is in possession of both the credit card information and the authenticating CVV2 information. However, it is undesirable to store the two together, particularly at a centralized location. Accordingly, if the CVV2 is stored separately from the credit card information at EEPROM 300, when scanning the information in RFID wristband 140 in step 502, one of the indicated blocks to be read in accordance with step 506 would be the CVV2 data which would be passed on, but not saved at central hub 110 to facilitate processing of credit card transactions by third party 180. In this way, the credit card information is completely isolated from the CVV2 information, but the two are able to work together in a time efficient manner.

The above examples contemplate the storage of ID data, signatures, transaction ID data such as CVV2 within the address blocks as part of the data that is rewritten. However, in an alternative embodiment, to further ensure the integrity of the data, data which need only be written once may be written to a READ ONLY location 302n, while transactional data which changes with each order, may be locations 302 which are operated upon in accordance with blocks 2-15.

Furthermore, the method and apparatus was described with only two alternating block groups. However, it is well within the scope of the invention to use two or more block groups to provide an archived history of transactional changes over a predetermined number of purchase orders. However, one wishing to maximize “real estate” on wristband 140 would use the preferred embodiment of two alternating groups. Furthermore, under the control of the RFID interrogator, it is within the scope of the invention to select specific blocks addressed within a block group while not reading others. By way of example, at certain access points, date of birth need not always be read, or a pointer may be provided in the written block to reference an original written block for non-changing data such as date of birth in an alternative embodiment.

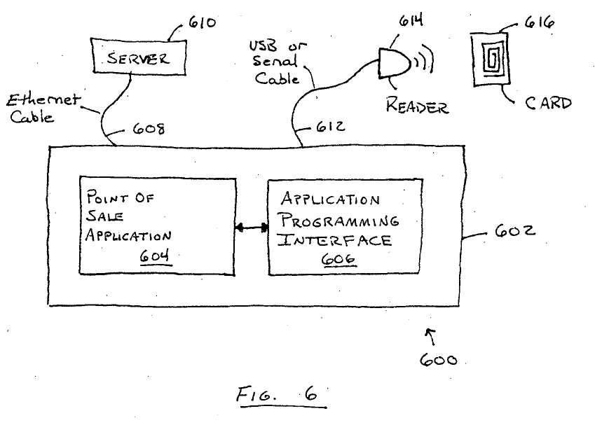

FIG. 6 illustrates a system 600 in which an RFID reader is incorporated into a point of sale (POS) device 602. The point of sale device 602, typically a specialized computer, is running a point of sale application 604 compatible with a point of sale standard, such as the Open Point-of-Sale standard, the JAVA Point-of-Sale standard, or the Unified Point-of-Sale (UPOS) standard. The point of sale device 602 is also running an application programming interface (API) 606 that communicates with the point of sale application 604, for example, UPOS, and also interacts with an external server 610 via an ethernet cable 608 and with an RFID reader 614 via a USB or serial cable 612. In a typical transaction operation, the API 606 receives an inquiry from the UPOS 604 for payment information. The API 606 then instructs the RFID reader 614 to scan for an RFID card 616 (or other RFID device). When the RFID reader 614 reader returns an RFID identity to the API 606, the API 606 queries the server 610 to check the validity of the RFID identity and to determine payment authorization, for example, determining whether adequate funds are available for the transaction or whether the user associated with the RFID identity is authorized to make the purchase. If the RFID identity is authorized to make payment, the server debits the associated user's account and transmits payment information back to the API 606. The API 606 then communicates with the UPOS 604 to indicate payment and complete the transaction. By using a Point of Sale standard, such as UPOS, an RFID reader 614 and computer server 610 can take advantage of programming libraries and protocols already in existence to seamlessly integrate an RFID cashless payment system into a sales infrastructure. Please note that the RFID card 616 may include an EEPROM module containing additional information that may be communicated to the server 610 or to the point of sale application 604 via the API 606.

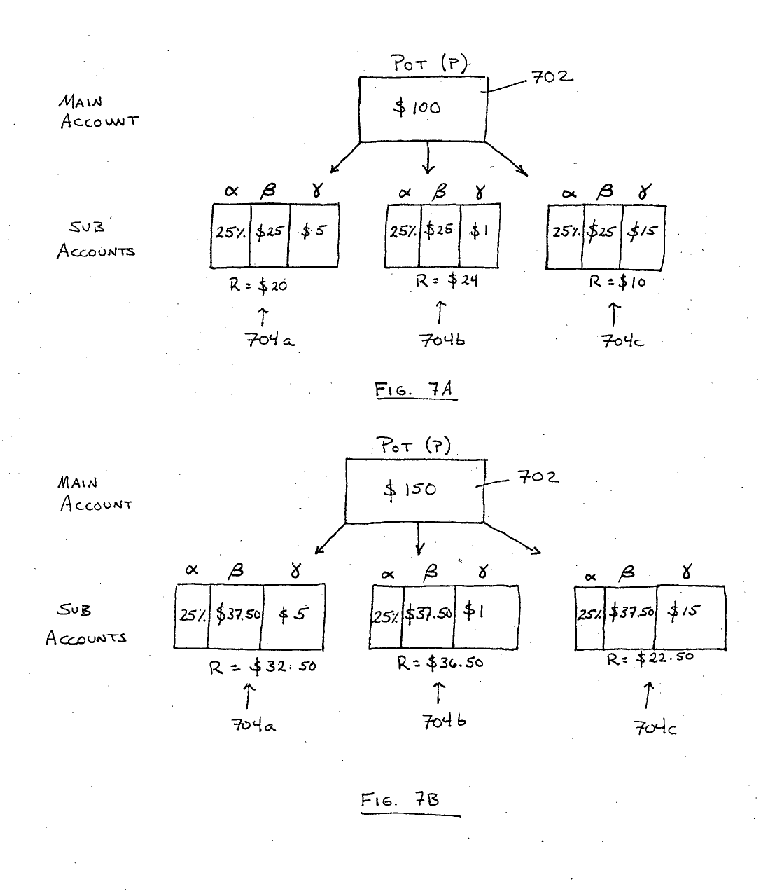

FIGS. 7A and 7B illustrate a method for tracking a spending account accessible by RFID bracelet and shared by several people. Examples of shared spending accounts include a family in which a parent authorizes several children to be able to make purchases using their individual RFID bracelets and business events in which an event sponsor authorizes individual participants to make purchases against the sponsor's account using their individual RFID bracelets. Please note that RFID bracelets are used in these examples because bracelets are a common format for RFID transmitters. RFID transmitters may be implemented in other forms, for example, cards. The spending account may be tracked in real time by a central server connected to point-of-sale devices that read the RFID bracelets or by being stored on EEPROM units mounted to each bracelet. FIG. 7A illustrates a first situation in which a main account 702 is started with a $100 pot P. Three subaccounts 704a-c are created. Each subaccount has three data fields associated with it: an allocation of the pot (α); a dollar value of the allocation (β); and an amount spent (γ). In the example shown in FIG. 7A, each subaccount 704a-c has an allocation of 25% of the pot, which is $25. The person with an RFID bracelet associated with subaccount 704a has spent $5 whereas the persons with RFID bracelets associated with subaccounts 704b and 704c have spent $1 and $15, respectively. Thus, subaccounts 704a, 704b, and 704c each have remaining balances of $20, $24, and $10, respectively.

FIG. 7B illustrates a second situation wherein the person responsible for the spending account adds $50 to pot P, resulting in a total pot P of $150. Again, the allocations to each subaccount 704a-c is 25%, so each account now gets $37.50. However, since subaccount 704a has already made $5 in purchases, only $32.50 remains. Likewise, subaccounts 704b and 704c, which spent $1 and $15, respectively, have remainders of $36.50 and $22.50, respectively.

An example use for the method of tracking a shared spending account demonstrated in FIGS. 7A and 7B would be a family with several children. For example, a parent would control the main account 702. A different child would be associated with each subaccount 704a-c and wear a corresponding RFID bracelet. In this way, the parent can provide spending money to the children with limitations on the amount the children can spend. Note that the allocations may vary from one subaccount to the next. For example, older children may be given a higher allocation than younger children. Note also that additional information fields may be included with each subaccount. For example, a fourth field may be added to a subaccount to include the remainder R for the subaccount. Alternatively, the remainder may be computed by a point-of-sale device or a server connected to the point-of-sale device by subtracting the amount spent field γ from the amount allocated field β.

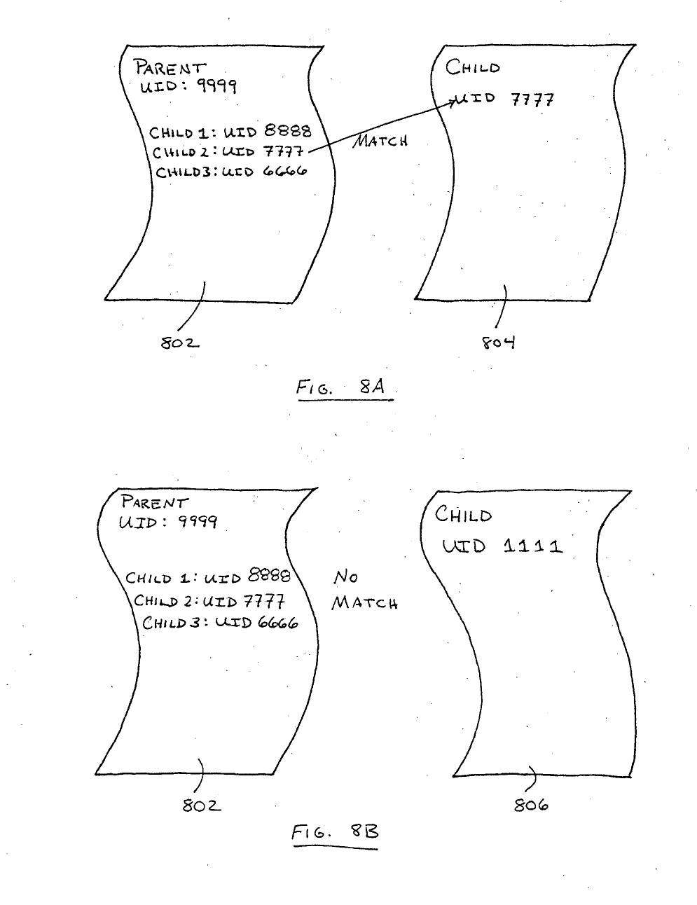

FIGS. 8A and 8B illustrate a method for tracking and properly matching parents with children using RFID bracelets. Each person at an event is issued a RFID bracelet upon admission to the event, which is assigned a unique identification (UID) number. For example, a parent may be issued the number 9999 and his three children may receive the numbers 8888, 7777, 6666. The parent's UID is associated with each of his children's UIDs. Also, the childrens' UID information may be associated with the parent's UID. The UID may be stored on a server connected to RFID readers or may be stored on each RFID bracelets on a EEPROM module. When a parent wishes to leave the event area with a child, both the parent's RFID bracelet and the child's RFID bracelet are scanned by a reader. FIG. 8A shows a printed receipt 802 for the parent's RFID bracelet, listing the parent's UID and the UID of his three children. A second printed receipt 804 for the child is also printed, showing the child's UID. Because the UID on the child's receipt matches a UID on the parent's receipt, the parent is permitted to leave with the child. Note that for extra security, the child's receipt may also include the parent's UID. Also, note that the RFID readings may be printed to a computer screen rather than being printed out in hardcopy form. Additionally, the display may simply indicate a match or a no-match situation rather than displaying actual UIDs.

FIG. 8B shows an instance in which the child's receipt 806 contains a UID not included on the parent's receipt 802. In this case, the person scanning RFID bracelets should assume that the parent is not properly matched with the child and should prevent the parent from leaving with the child. Such a system can help prevent kidnapping at a busy and crowded venue, such as an amusement park. Such a system may also help to prevent cases of mistaken identity, such as at a maternity ward where a parent may inadvertently be paired with the wrong child.

While this invention has been particularly shown and described with references to example embodiments thereof, it will be understood by those skilled in the art that various changes in form and details may be made therein without departing from the scope of the invention encompassed by the appended claims.

What is claimed is:

1. A method for purchasing goods or services utilizing an RFID apparatus, the RFID apparatus including an EEPROM, the EEPROM containing a first group of data blocks and a second group of data blocks, the purchase of goods being performed in connection with an RFID scanner comprising the steps of:
storing transaction data in respective data blocks of one of the first group of data blocks or the second group of data blocks of the EEPROM;
placing an order for goods or services utilizing the RFID scanner;
reading a start block pointer value from a data block of the EEPROM,
the pointer value corresponding to the address of a last written of the first group of data
blocks or the second group of data blocks;
reading data from the last written group of data blocks;
modifying the transaction data in accordance with the purchase order to create modified data;
writing the modified data to one of the first group of data blocks or the second group of data blocks which is not the last written database;
determining whether the writing to one of the first group or the second group of data blocks is successful, and changing the pointer value to indicate the group of data blocks containing the modified data.

2. The method of claim 1, further comprising the step of storing a signature in a data block of the EEPROM.

3. The method of claim 1, further comprising the steps of storing a CVV2 information in a data block of the EEPROM;
storing a credit card number associated with the RFID wristband at a central hub;
transmitting the order along with the CVV2 information to the central hub, the central hub authorizing the order, as a function of the receipt of the CVV2 information.

4. The method of claim 3, wherein the central hub transmits the credit card information and CVV2 data to a third party for authorization, the central hub authorizing the order in response to an authorization indication from the third party.

5. A method for maintaining purchase authorization information utilizing an RFID apparatus, comprising:
purchasing goods or services with the RFID apparatus, the RFID apparatus storing information associating a customer with an account, and a signature;
purchasing goods or services by reading information from the RFID apparatus including the signature; and
authorization for the purchase being granted upon receipt of the signature.

6. The method of claim 5, wherein the RFID apparatus is a wristband, the wristband containing an EEPROM, the signature being stored in the EEPROM.

7. The method of claim 6, wherein said signature is stored as one of a vector map.

8. The method of claim 5, further comprising the steps of: storing a CVV2 value in a data block of the EEPROM; and
storing a credit card number associated with the RFID apparatus at a central hub, transmitting the order along with the CVV2 information to the central hub, the central hub authorizing the order as a function of the receipt of the CVV2 data.

9. The method of claim 8, wherein the central hub transmits the credit card information and CVV2 information to a third party for authorization, the central hub authorizing the order in response to an authorization indication from the third party.

10. A method for maintaining purchase authorization information utilizing an RFID apparatus, comprising:
storing a credit card number associated with the RFID wristband at a central hub;
purchasing goods or services with the RFID apparatus, the RFID apparatus storing information associating a customer with an account, and CVV2 information;
purchasing goods or services by reading information from the RFID apparatus including CVV2 information;
authorization for the purchase being granted upon receipt of the CVV2 information; and
transmitting the order along with the CVV2 information to the central hub, the central hub authorizing the order as a function of the receipt of the CVV2 information.

11. The method of claim 10, wherein the central hub transmits the credit card information and CVV2 data to a third party for authorization, the central hub authorizing the order in response to an authorization indication from the third party.

12. An RFID system for transacting purchases for goods and services, comprising:
a point-of-sale computer with standardized point-of-sale application software and RFID application programming interface software;
a server coupled to the point-of-sale computer and configured to store data related to RFID tags and to transmit the data to the point-of-sale computer when queried by the RFID application programming interface software;
an RFID reader coupled to the point-of-sale computer and configured to read RFID tags when queried by the RFID application programming interface software;
the standardized point-of-sale application software querying the RFID application programming interface software for a payment and completing a transaction when the payment is received; and
the RFID application programming interface software, in response to a query from the standardized point-of-sale application software, querying the RFID reader for RFID tag information and receiving the RFID tag information, querying the server for authorization to charge the payment to an account associated with the RFID tag information, and sending payment to the standardized point-of-sale application software.

13. The RFID system of claim 12, where the standardized point-of-sale application software is one of the: Open point-of-sale standard; JAVA point-of-sale standard; and Unified point-of-sale standard.

14. The RFID system of claim 12 wherein the RFID tags are each coupled to EEPROM modules that store data, which is further read by the RFID application programming interface software.

15. A method of preventing child abduction at a limited-access venue, comprising the steps of:
providing RFID tags to a responsible adult and each child for whom the adult is responsible;
associating the adult's RFID tag with the RFID tag of each child for whom the adult is responsible; and
when a child attempts to depart the venue, scanning the departing child's RFID tag and the RFID tag of a departing adult claiming responsibility for the departing child and only allowing the departing child to depart if the departing adult's RFID tag is associated with the departing child's RFID tag.

16. The method of claim 15 wherein the adult's RFID tag is associated with the RFID tag of each child for whom the adult is responsible by recording unique identification numbers associated with each child's RFID tag onto an EEPROM coupled to the adult's RFID tag.

17. A method of managing a spending account accessible by multiple RFID tags comprising:
providing RFID tags to a plurality of individuals, each RFID tag having a distinct identification;
associating the provided RFID tags with a common account and associating each RFID tag with a distinct account;
assigning to each RFID tag an allocation percentage; and
allocating money placed in the common account to the distinct account associated with each RFID tag according to allocation percentage associated with each RFID tag.

18. The method of claim 15 wherein the allocation percentage and money allocated to the distinct account associated with each RFID tag is stored on an EEPROM coupled to the RFID tag.
